(19) United States
(12) Patent Application Publication
(10) Pub. No.: US 2021/0039611 A1
(43) Pub. Date: Feb. 11, 2021

(54) TRUCK TIRE STOP WITH PLATFORM

(71) Applicant: Kevin Ross Clement, Grande Prairie (CA)

(72) Inventor: Kevin Ross Clement, Grande Prairie (CA)

(21) Appl. No.: 16/569,652

(22) Filed: Sep. 12, 2019

(30) Foreign Application Priority Data
Aug. 9, 2019 (CA) 3051568

(51) Int. Cl. B60T 3/00

(52) U.S. Cl. CPC B60T 3/00

(57) ABSTRACT

An apparatus for providing a tire stop for a truck proximate to an open pit comprising a base plate having top and bottom surfaces, the base plate extending between first and second side edges, and between proximate and distal edges, an elongate horizontal stopping member extending parallel to at least one of the proximate and distal edges and supported by a plurality of vertical support brackets extending from the top surface of the base plate, wherein the plurality of vertical support brackets may be configured to position the horizontal stopping member above the top surface of the base plate with a gap therebetween; and a horizontal platform extending above the base plate along the first, second and proximate edges.

### BACKGROUND OF THE INVENTION

### 1. Field of Invention

The present invention relates generally to the dumping of tank trucks and in particular to an apparatus adapted to provide a tire stop and work platform for a tank truck proximate to an open pit.

### 2. Description of Related Art

Tank trucks, also known as vacuum or vac trucks, include a pump and a tank, and are used to suck liquids or slurries from a location into the truck's tank. The material is then transported to another location, such as a disposal site or treatment facility, into which the tank is emptied.

To empty the tank, the truck must be located in close proximately to the disposal site. In some cases, the disposal site is an open pit or excavation, which can be soft, muddy and slippery. These conditions can be hazardous to the operator, who must position the truck sufficiently close to the open pit to access it with hoses attached to the truck, then work around the rear end of the truck to dispose of the materials therein.

### SUMMARY OF THE INVENTION

According to a first embodiment of the present invention there is disclosed an apparatus for providing a tire stop for a truck proximate to an open pit comprising a base plate having top and bottom surfaces, the base plate extending between first and second side edges, and between proximate and distal edges, an elongate horizontal stopping member extending parallel to at least one of the proximate and distal edges and supported by a plurality of vertical support brackets extending from the top surface of the base plate, wherein the plurality of vertical support brackets may be configured to position the horizontal stopping member above the top surface of the base plate with a gap therebetween; and a horizontal platform extending above the base plate along the first, second and proximate edges.

The base plate may include a lip extending from the top surface of the base plate to a lip top surface along the first, second and proximate edges. The base plate may include a sloped spill plate extending between the lip top surface along the proximate edge and the base plate top surface proximate to this distal edge.

The horizontal platform may be comprised of a grating floor surface supported by a platform frame. The horizontal platform may include railings extending therefrom. The horizontal platform may include folding stairs extending therefrom. The apparatus may further comprise removable stairs adapted to access the horizontal platform.

The apparatus may further comprise a pair of guide apertures extending from the base plate, wherein each of the guide apertures may be adapted to slidably receive an elongate pile therethrough.

The apparatus may further comprise a pair of block bases extending from the base plate, wherein each of the block bases may be adapted to receive a concrete block thereon.

The apparatus may further comprise a quick connect pipe fitting. The apparatus may further comprise a tube extending from the quick connect pipe to a distal end positionable within the open pit.

The stopping member may be a pipe extending between distal pipe ends. The distal pipe ends may extend beyond the plurality of vertical support brackets. A portion of the pipe may be cut through a horizontal axis at each of the distal pipe ends such that each of the distal pipe ends may be formed of a half pipe open at a top thereof. The half pipe may be covered with floor grating.

The horizontal platform may be formed in a U shape, extending along a full length of the first, second and distal edges of the base plate.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of an apparatus for providing a tire stop for a truck proximate to an open pit.

FIG. 2 is a top view of the apparatus of FIG. 1.

FIG. 3 is a side cross-sectional view of the apparatus of FIG. 1 as taken along the line 3-3.

FIG. 4 is a front elevation view of the apparatus of FIG. 1, with railings removed for clarity.

FIG. 5 is a perspective view of one corner of the apparatus of FIG. 1, with a concrete block positioned on a base secured to the apparatus.

FIG. 6 is a top plan view of the apparatus of FIG. 1.

### DETAILED DESCRIPTION

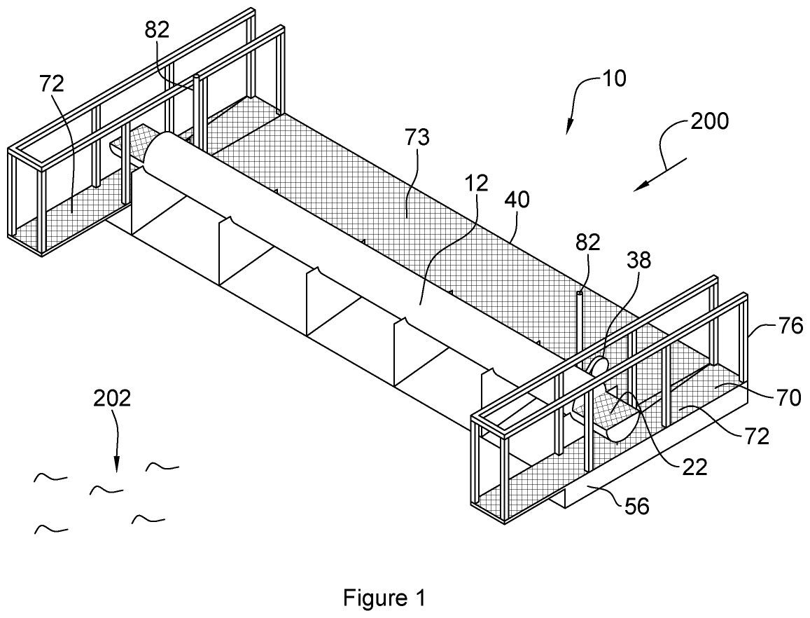

Referring to FIG. 1, an apparatus for providing a tire stop for a truck proximate to an open pit according to a first embodiment of the invention is shown generally at 10. The apparatus 10 may be used to provide a safe stopping location for a truck, as well as a safe working platform on which operators may be protected from the dangers of an open pit while cleaning out a tank on the truck.

The apparatus 10 comprises a stopping member 12 supported by a plurality of vertical supports 30 extending from a base 40 which has a working platform 70 extending at least partially therearound. A truck (not shown) may approach the apparatus 10 in a direction generally indicated at 200 proximate to an open pit generally indicated at 202.

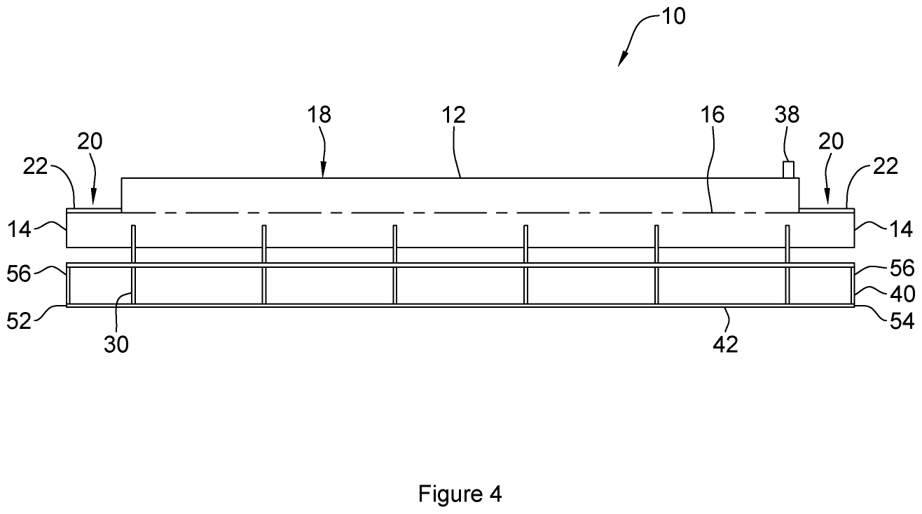

Referring to FIGS. 1 through 4, the base 40 includes a base plate 42 having top and bottom surfaces 44 and 46, respectively, and extending between proximate and distal edges, 48 and 50, respectively, and first and second side edges, 52 and 54, respectively. An upright lip 56 extends from the top surface 44 of the base plate 42 to a lip top surface 58 along the first side, second side and proximate edges 52, 54 and 48. A sloped spill plate 60 extends between top and bottom edges, 62 and 64, respectfully, with the top edge 62 located on the lip top surface 58 at the proximate edge 48 and the bottom edge 64 located on the top surface 44 of the base plate 42 proximate to the distal edge 50. The spill plate 60 includes a plurality of slots or apertures 66 therethrough, corresponding to the plurality of vertical supports 30, as will be set out below. The spill plate 60 and lip 56 direct any spills from the truck towards the distal edge 50 and into the open pit 202.

The stopping member 12 extends between distal ends 14 along an axis 16 which extends parallel to the proximate edge 48. It will be appreciated that the stopping member 12 may extend parallel to the distal edge 50, as well. The stopping member 12 includes a stopping portion 18 extending between step end portions 20 at the distal ends 14. The stopping member 12 is formed of a pipe which has been cut radially and axially at the distal ends 14 to form a half pipe, as is commonly known, at the step end portions 20. An end step 22 is formed of floor grating, as is commonly known, adapted to enclose the open half pipe at the step end portions 20. The end step 22 is secured to the step end portions 20 be means as are commonly known, such as, by way of non-limiting example, a frame attached by mechanical fasteners or spot welding. The length of each end step 22 is selected to correspond with the working platform 70, as will be set out further below.

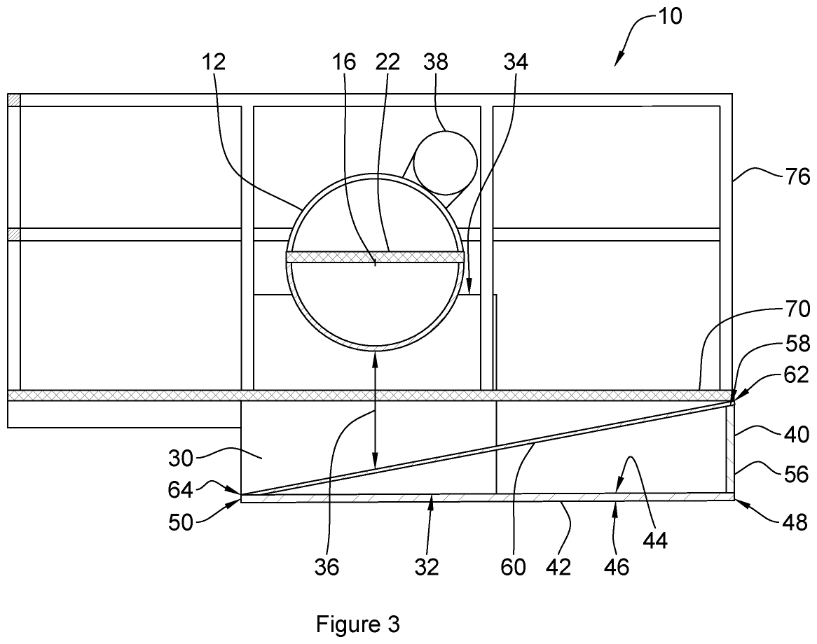

The stopping member 12 is supported by a plurality of vertical supports 30, as set out above, distributed along the length of the stopping member 12. While six vertical supports 30 are illustrated herein, it will be appreciated that more or less vertical supports 30 may be useful, as well. As best illustrated in FIG. 3, each vertical support 30 extends from a lower edge 32 secured to the top surface 44 of the base plate 42 to a top support edge 34. The top support edge 34 is adapted to engage upon the stopping member 12 and is secured thereto by means as are commonly known, such as, by way of non-limiting example, mechanical fasteners or spot welding. As set out above, the spill plate 60 includes slots or apertures 66 therethrough such that each vertical support 30 extends through a slot or aperture 66. It will also be appreciated that the spill plate 60 may be comprised of a series of spill plates selected to extend between each pair of vertical supports 30. The height of the vertical supports 30 is selected to provide a gap 36 between the stopping member 12 and the spill plate 60 to allow for any spills from the truck tank to pass therethrough.

A quick connect pipe fitting 38 may be secured to the apparatus 10 at any location. As illustrated in the accompanying figures, the quick connect 38 is secured to the stopping member 12 on the stopping portion 18 proximate to a distal end step portion 20. The purpose of the quick connect 38 is to provide a convenient access point to secure a solid pipe or flexible hose to.

The working platform 70 extends around apparatus 10 and includes side platforms 72 above the first and second side edges 52 and 54 and a front platform 73 above the proximate edge 48 over which the truck may approach the stopping member 12. The working platform 70 may be formed as is commonly known in the art, with floor grating secured to a metal frame. The end step portions 20 allow access over the stopping member 12. Railings 76 are included at the edges of the side platforms 72 for added safety, as is commonly known. The railings 76 may include at least one gate therethrough (not shown), to provide entry and exit from the working platform 70. A set of stairs (not shown) may also be included to provide access to the working platform 70. It will be appreciated that the stairs may be secured to the working platform 70 and may fold up for storage, or the stairs may be removable from the working platform 70.

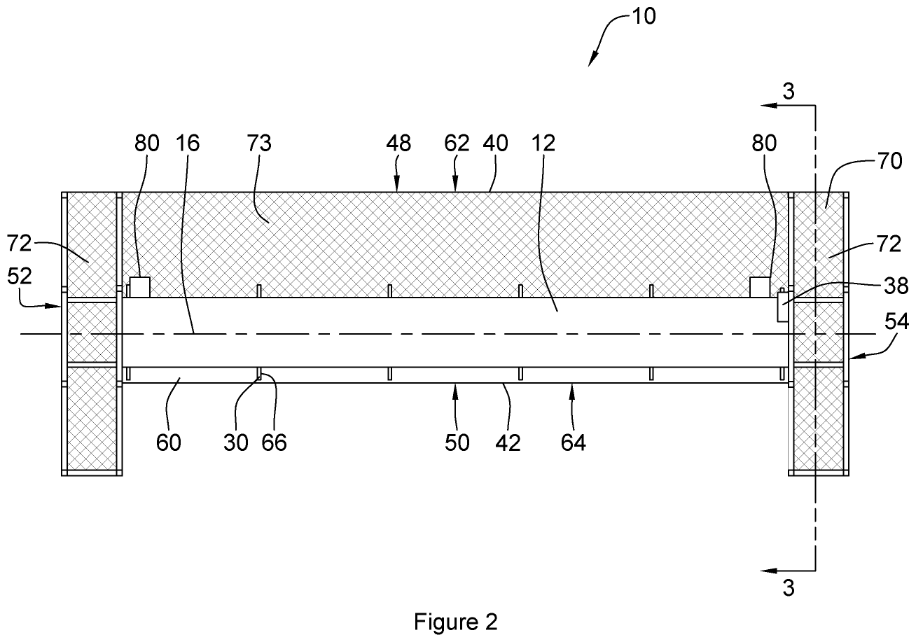

The apparatus 10 includes a pair of guide apertures 80, as illustrated in FIGS. 1 and 2. The guide apertures 80 extend through the base 40 and each guide aperture 80 provides a passage for a pile 82, as is commonly known, to pass therethrough. Piles 82 are embedded in the ground beneath the apparatus 10 to secure it in place, as is commonly known. The piles 82 may extend above the stopping member 12, as illustrated in FIG. 1, to provide a backup marker for the truck operator.

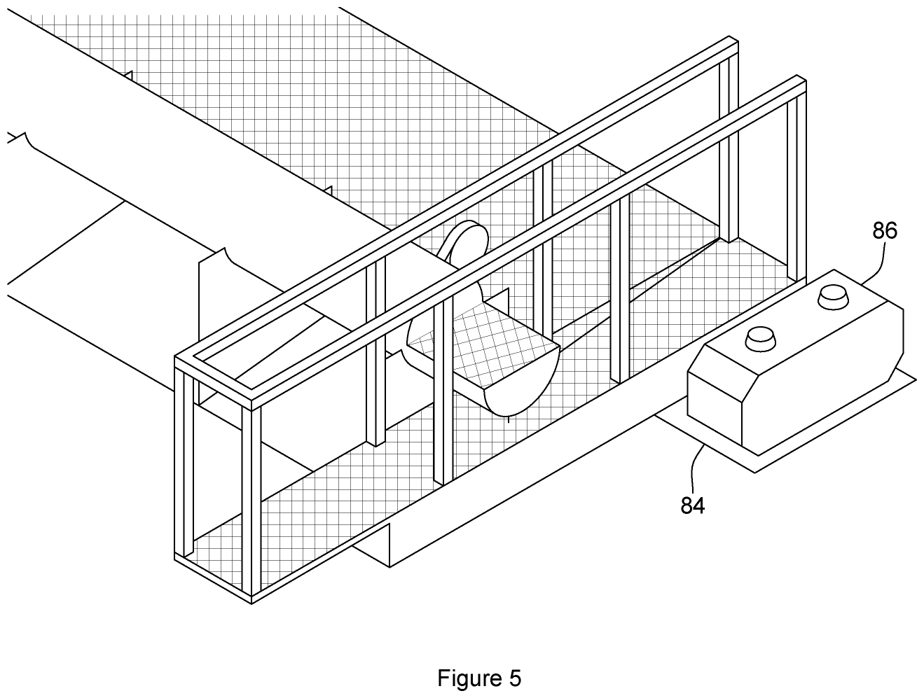

Alternately, as illustrated in FIG. 5, at least one block base 84 may extend from the base 40 to provide a surface for a concrete block 86 to engage upon, thereby securing the apparatus 10 in place. The apparatus 10 may include a plurality of block bases 84 each adapted to receive a concrete block 86 thereon.

To utilize the apparatus 10, the apparatus 10 is placed in proximity to an open pit 202 and secured in place with either piles 82 or concrete blocks 86, as set out above. An operator then reverses a tank truck towards in the apparatus 10 in the direction indicated at 200 until the rear tires of the truck engage upon or the stopping member 12 wherein the tires may be located adjacent to or on the front platform 73. The operator may then access the working platform 70 and connect a pipe or tube between the truck and the quick connect 38, with an additional pipe or tube connected to the quick connect 38 and directed into the open pit 202. The operator is able to access the rear end of the truck from the working platform 70 such that the truck may be emptied into the pit 202, as is commonly known. It will be appreciated that the empty space behind the stopping member 12 will permit the truck to be emptied into the pit and the grating forming the working platform 70 will permit any spilled liquids to flow therethrough and down the spill plate which will also direct such materials into the pit 202.

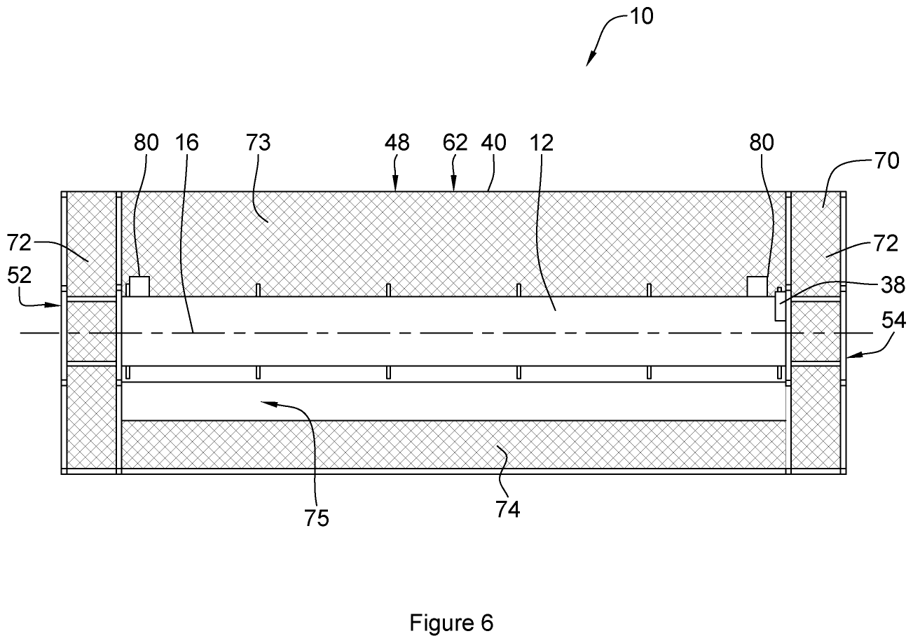

Turning now to FIG. 6, optionally, the platform 70 may include an end platform 74 which may between the side platforms 72. The end platform 74 may extend beyond the distal edge 50, as illustrated. The end platform 74 may optionally include a railing therearound as is commonly known and may also be horizontally spaced apart from the stopping member 12 by a gap distance 75 thereby permitting materials discharged from the truck to flow therethrough. It will also be appreciated that other safety equipment may be located on or suspended from the apparatus 10 such as, by way of non-limiting example, ropes, life jackets and buoys.

While specific embodiments of the invention have been described and illustrated, such embodiments should be considered illustrative of the invention only and not as limiting the invention as construed in accordance with the accompanying claims.

What is claimed is:

1. An apparatus for providing a tire stop for a truck proximate to an open pit comprising:
a base plate having top and bottom surfaces, said base plate extending between first and second side edges, and between proximate and distal edges;
an elongate horizontal stopping member extending parallel to at least one of said proximate and distal edges and supported by a plurality of vertical support brackets extending from said top surface of said base plate;
wherein said plurality of vertical support brackets are configured to position said horizontal stopping member above said top surface of said base plate with a gap therebetween; and
a horizontal platform extending above said base plate along said first, second and proximate edges.

2. The apparatus of claim 1 wherein said base plate includes a lip extending from said top surface of said base plate to a lip top surface along said first, second and proximate edges.

3. The apparatus of claim 2 wherein said base plate includes a sloped spill plate extending between said lip top surface along said proximate edge and said base plate top surface proximate to said distal edge.

4. The apparatus of claim 1 wherein said horizontal platform is comprised of a grating floor surface supported by a platform frame.

5. The apparatus of claim 1 wherein said horizontal platform includes railings extending therefrom.

6. The apparatus of claim 1 wherein said horizontal platform includes folding stairs extending therefrom.

7. The apparatus of claim 1 further comprising removable stairs adapted to access said horizontal platform.

8. The apparatus of claim 1 further comprising a pair of guide apertures extending from said base plate, wherein each of said guide apertures is adapted to slidably receive an elongate pile therethrough.

9. The apparatus of claim 1 further comprising a pair of block bases extending from said base plate, wherein each of said block bases is adapted to receive a concrete block thereon.

10. The apparatus of claim 1 further comprising a quick connect pipe fitting.

11. The apparatus of claim 10 further comprising a tube extending from said quick connect pipe to a distal end positionable within the open pit.

12. The apparatus of claim 1 wherein said stopping member is a pipe extending between distal pipe ends.

13. The apparatus of claim 12 wherein said distal pipe ends extend beyond said plurality of vertical support brackets.

14. The apparatus of claim 12 wherein a portion of said pipe is cut through a horizontal axis at each of said distal pipe ends such that each of said distal pipe ends is formed of a half pipe open at a top thereof.

15. The apparatus of claim 14 wherein said half pipe is covered with floor grating.

16. The apparatus of claim 1 wherein said horizontal platform is formed in a U shape, extending along a full length of said first, second and distal edges of said base plate.
